(19) United States
(12) Patent Application Publication
(10) Pub. No.: US 2025/0249847 A1
(43) Pub. Date: Aug. 7, 2025

(54) BAND CLAMP AND WIRE HARNESS

(71) Applicant: YAZAKI CORPORATION, Tokyo (JP)

(72) Inventors: Takuya Nakada, Makinohara-shi (JP); Hiroki Suematsu, Makinohara-shi (JP)

(21) Appl. No.: 19/031,224

(22) Filed: Jan. 17, 2025

(30) Foreign Application Priority Data
Feb. 2, 2024 (JP) 2024-014656

(51) Int. Cl. B60R 16/02; H02G 3/32

(52) U.S. Cl. CPC B60R 16/0215; H02G 3/32

(57) ABSTRACT

A band clamp includes a clip part, a flange part, a lock part, and a band part. The flange part is provided with a guide surface inclined toward the other end side in an attachment direction as it is separated from an open end of a band insertion port toward one end side in a width direction of the flange part. The open end is provided with a pair of tapered surfaces inclined so as to spread toward both sides in an axial direction as it is closer to the one end side in the width direction of the flange part. The lock part protrudes such that one end side in the attachment direction of the open end is positioned closer to the one end side in the width direction of the flange part than the other end side.

### CROSS-REFERENCE TO RELATED APPLICATION(S)

The present application claims priority to and incorporates by reference the entire contents of Japanese Patent Application No. 2024-014656 filed in Japan on Feb. 2, 2024.

### BACKGROUND OF THE INVENTION

### 1. Field of the Invention

The present invention relates to a band clamp and a wire harness.

### 2. Description of the Related Art

As a conventional technology related to a band clamp of a wire harness, for example, Japanese Patent Application Laid-open No. 2020-118209 A discloses a band clamp including a clip part fitted into an attachment hole provided on an attachment target in an attachment direction, a flange part provided on one end side in the attachment direction of the clip part and formed to have a diameter larger than that of the clip part, a lock part provided on one end side in the attachment direction of the flange part in which a band insertion port penetrating in a width direction intersecting the attachment direction is formed, and a band part protruding from the lock part in a band shape and locked to the band insertion port in a state of being wound around a wiring member.

Meanwhile, in the band clamp disclosed in Japanese Patent Application Laid-open No. 2020-118209 A, for example, there has been a room for further improvement in terms of improving an insertion property of a band part into a band insertion port of a lock part.

### SUMMARY OF THE INVENTION

The present invention has been achieved in view of the above circumstances, and an object thereof is to provide a band clamp and a wire harness capable of improving an insertion property of a band part into a band insertion port of a lock part.

In order to achieve the above mentioned object, a band clamp according to one aspect of the present invention includes a clip part configured to fit into an attachment hole provided on an attachment target in an attachment direction; a flange part provided on one end side of the clip part in the attachment direction and formed to have a diameter larger than a diameter of the clip part; a lock part provided on one end side of the flange part in the attachment direction in which a band insertion port penetrating in a width direction intersecting the attachment direction is formed; and a band part that protrudes in a band shape from the lock part and is locked to the band insertion port in a state of being wound around a wiring member extending in an axial direction intersecting the attachment direction and the width direction, wherein the flange part is provided with a guide surface inclined toward the other end side in the attachment direction as the guide surface is separated from an open end of the band insertion port toward one end side of the flange part in the width direction, the open end is provided with a pair of tapered surfaces inclined so as to spread toward both sides in the axial direction as the taper surfaces are closer to one end side of the flange part in the width direction, and the lock part protrudes such that one end side of the open end in the attachment direction is positioned closer to one end side of the flange part in the width direction than the other end side of the open end.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an illustrative cross-sectional view of a band clamp applied to a wire harness according to an embodiment;

FIG. 2 is an exemplary plane view of a lock part of the band clamp according to the embodiment; and

FIG. 3 is an exemplary cross-sectional view of a clip part of the band clamp according to the embodiment.

### DETAILED DESCRIPTION OF THE PREFERRED EMBODIMENTS

Hereinafter, an embodiment according to the present invention will be described in detail with reference to the drawings. Note that, this invention is not limited by the following embodiment. Components in the following embodiment include the components easily replaced by those skilled in the art or substantially identical components. Note that, in the present specification, ordinal numbers are used only to distinguish parts, members, sites, positions, directions and the like, and do not indicate order or priority.

### Embodiment

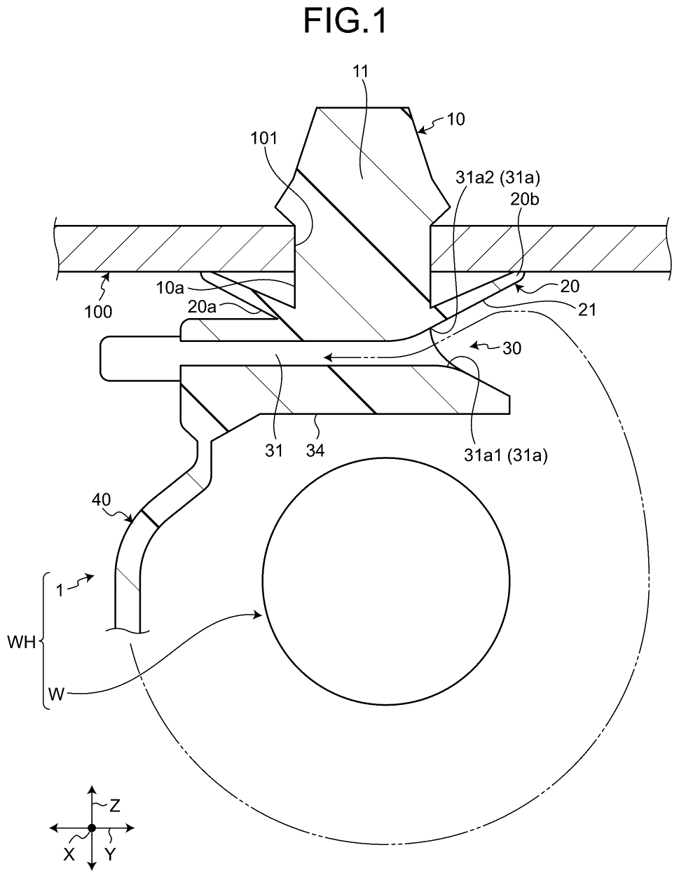

FIG. 1 is a cross-sectional view of a band clamp 1 applied to a wire harness WH according to an embodiment. The band clamp 1 of the present embodiment illustrated in FIG. 1 is incorporated in the wire harness WH wired in a vehicle such as an automobile. Here, for example, the wire harness WH is configured such that wiring members W used for power supply and signal communication are bundled to form a collective part for connection between devices mounted on the vehicle, and the wiring members W are connected to the devices by a connector or the like. The wire harness WH of the present embodiment includes the wiring member W having conductivity and the band clamp 1 that supports the wiring member W. Note that, in addition to them, the wire harness WH may further include various parts such as a grommet, an electrical connection box, and a fixing tool.

Note that, in the following description, among first, second, and third directions intersecting one another, the first direction is referred to as an “axial direction X”, the second direction is referred to as a “width direction Y”, and the third direction is referred to as an “attachment direction Z”. Here, the axial direction X, the width direction Y, and the attachment direction Z are substantially orthogonal to one another. The axial direction X is typically along an extending direction of the wiring member W, an insertion direction of the wiring member W with respect to the band clamp 1 and the like. The width direction Y is typically along a width direction or the like of the band clamp 1. The attachment direction Z is typically along an attachment direction of the band clamp 1 with respect to an attachment panel 100, a height direction (vertical direction) of the band clamp 1, a plate thickness direction of the attachment panel 100 and the like. Each direction used in the following description will be described as a direction in a state in which the band clamp 1 is assembled to the vehicle unless otherwise specified.

The wiring member W is formed of, for example, a metal rod, an electric wire, an electric wire bundle and the like. The metal rod is formed by covering an outer side of a rod-shaped member having conductivity with a covering having an insulation property. The electric wire is obtained by covering an outer side of a conductor (core wire) made of a plurality of conductive metal wires with a covering having an insulation property. The electric wire bundle is obtained by bundling these electric wires. In an example of FIG. 1, the wire harness WH includes one wiring member W, but is not limited thereto, and may include a plurality of wiring members W. The wiring member W extends in the axial direction X.

The band clamp 1 is fixed to an attachment hole 101 formed on the attachment panel 100 as an attachment target. The attachment panel 100 is, for example, a metal plate forming a body, a floor panel and the like of the vehicle, and the attachment hole 101 is a through hole penetrating the attachment panel 100 in the attachment direction Z as the plate thickness direction. Then, the band clamp 1 is fixed to the attachment hole 101 in a state of being wound along an outer peripheral surface of the wiring member W, thereby being used as a member that regulates a wiring path of the wiring member W.

The band clamp 1 includes, for example, a clip part 10, a flange part 20, a lock part 30, and a band part 40. In the present embodiment, the clip part 10, the flange part 20, the lock part 30, and the band part 40 are integrally formed of the same resin material (for example, a thermoplastic resin such as polypropylene and nylon). In the band clamp 1, for example, the band part 40, the lock part 30, the flange part 20, and the clip part 10 are arranged in this order from one end (base end, lower end) side toward the other end (distal end, upper end) side in the attachment direction Z to be coupled to one another.

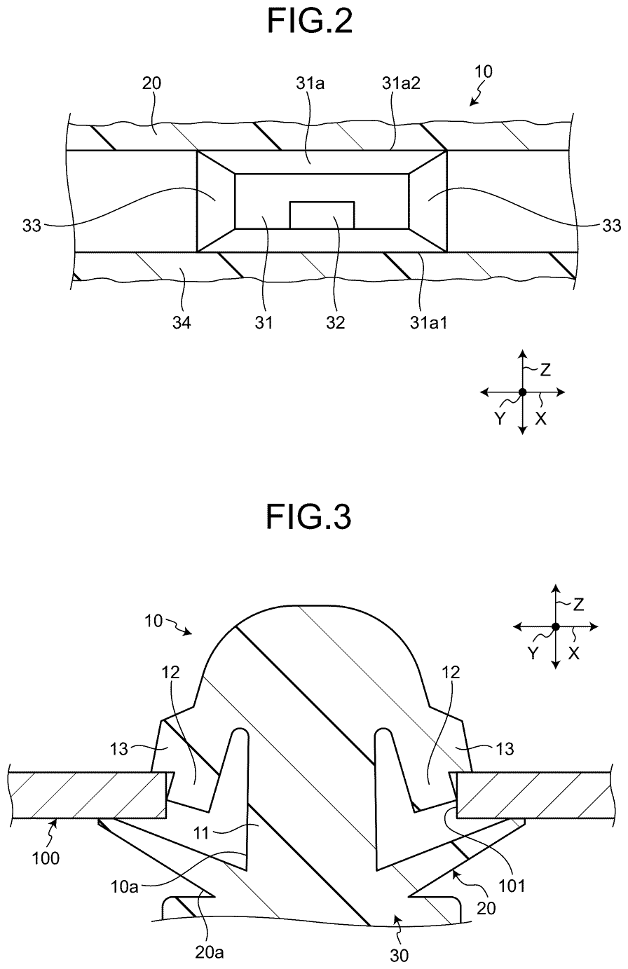

FIG. 2 is a plane view of the lock part 30 of the band clamp 1, and FIG. 3 is a cross-sectional view of the clip part 10 of the band clamp 1. As illustrated in FIG. 3, the clip part 10 is a portion fixed to the attachment panel 100. The clip part 10 includes, for example, a shaft 11, a pair of arms 12, and a pair of locking claws 13. The shaft 11 is formed to extend in a columnar shape in the attachment direction Z. The shaft 11 is attached in a state of penetrating the attachment hole 101 of the attachment panel 100 in the attachment direction Z.

The pair of arms 12 are formed at positions facing each other with the shaft 11 interposed therebetween in the axial direction X. The pair of arms 12 are formed into an arm shape protruding in the axial direction X from the other end (distal end) of the shaft 11 in the attachment direction Z and inclined so as to spread toward both sides in the axial direction X as it is closer to the one end 10a side of the shaft 11 in the attachment direction Z. In each of the pair of arms 12, the other end side in the attachment direction Z is coupled to the shaft 11, and the locking claw 13 is formed on one end side in the attachment direction Z.

The pair of locking claws 13 are portions locked to a peripheral edge of the attachment hole 101 formed on the attachment panel 100. The pair of locking claws 13 are formed in a claw shape on one end side in the attachment direction Z of the pair of arms 12. In the present embodiment, the clip part 10, in which the pair of arms 12 have flexibility, is formed so that the arm 12 can be inserted into the attachment hole 101 while being bent. The pair of arms 12 are inserted into the attachment hole 101 while being bent, and the pair of locking claws 13 are locked to the peripheral edge of the attachment hole 101, whereby the clip part 10 is fixed to the attachment panel 100.

The flange part 20 is a portion provided on one end 10a side in the attachment direction Z of the clip part 10, the portion formed to have a larger diameter than that of the clip part 10. The flange part 20 protrudes in a flange shape (disc shape) from one end 10a of the clip part 10 outward in a radial direction of the shaft 11. The flange part 20 supports one end side of the attachment panel 100 in the attachment direction Z, that is, a surface opposite to the pair of locking claws 13 described above. By the attachment panel 100 being interposed between the flange part 20 and the pair of locking claws 13, movement of the band clamp 1 with respect to the attachment panel 100 in the attachment direction Z is regulated.

The flange part 20 is provided with a guide surface 21 (refer to FIG. 1) that guides the band part 40 to be described later to an open end 31a side of a band insertion port 31. The guide surface 21 is formed on a back surface (lower surface) of the flange part 20 on one end 20a side in the attachment direction Z, that is, a side facing the band insertion port 31. The guide surface 21 is inclined toward the other end side in the attachment direction Z as it is separated from the open end 31a of the band insertion port 31 toward one end 20b side in the width direction Y of the flange part 20. The other end side of the guide surface 21 in the width direction Y is connected (coupled) to the open end 31a, and a distal end of the band part 40 can be guided into the band insertion port 31 by sliding the same along the guide surface 21.

The lock part 30 is provided on one end 20a side of the flange part 20 in the attachment direction Z, and is a portion in which the band insertion port 31 into which the band part 40 is inserted in the width direction Y is formed. The lock part 30 includes, for example, a lock part main body 34, the band insertion port 31, a locking tooth 32 (refer to FIG. 2), and a pair of tapered surfaces 33. The lock part main body 34 is a portion protruding in a wall shape in the attachment direction Z from one end 20a of the flange part 20 in the attachment direction Z. On the lock part main body 34, the band insertion port 31 penetrating the lock part main body 34 in the width direction Y is formed. As illustrated in FIG. 2, the band insertion port 31 is partially provided, for example, in a central portion of the lock part main body 34 in the axial direction X.

The locking tooth 32 is a portion to be locked with a locking groove not illustrated formed on the band part 40. The locking tooth 32 is provided on an inner surface of the band insertion port 31 and protrudes in the attachment direction Z. In the present embodiment, the band insertion port 31 is provided with a plurality of locking teeth 32 spaced apart from each other in the width direction Y. The lock part 30 can lock the distal end of the band part 40 inserted into the band insertion port 31 in the width direction Y by a locking structure between the plurality of locking teeth 32 and the locking groove of the band part 40.

The pair of tapered surfaces 33 are provided at the open end 31a of the band insertion port 31. The pair of tapered surfaces 33 are provided at both ends in the axial direction X of the open end 31a, and are inclined so as to spread toward both sides in the axial direction X as it is closer to the one end 20b (refer to FIG. 1) side in the width direction Y of the flange part 20 described above. In the pair of tapered surfaces 33, the other end side in the width direction Y is connected (coupled) to the inner surface of the band insertion port 31, and the distal end of the band part 40 can be guided into the band insertion port 31 by sliding the same along the pair of tapered surfaces 33.

Here, in the present embodiment, the lock part 30 protrudes in such a manner that one end 31a1 side in the attachment direction Z of the open end 31a is positioned closer to the one end 20b (refer to FIG. 1) side in the width direction Y of the flange part 20 than the other end 31a2 side. The one end 31a1 is an end of the open end 31a on the side opposite to the guide surface 21, and the other end 31a2 is an end of the open end 31a on the guide surface 21 side. In a case where the one end 31a1 side is recessed so as to be positioned closer to the other end side in the width direction Y of the flange part 20 than the other end 31a2 side, that is, in a case where the one end 31a1 is positioned on an extension line of the guide surface 21, there is a possibility that the distal end of the band part 40 guided along the guide surface 21 is detached without being inserted into the band insertion port 31. In this regard, in the present embodiment, since the one end 31a1 side protrudes so as to be positioned closer to the one end 20b side in the width direction Y of the flange part 20 than the other end 31a2 side, it is possible to suppress the distal end of the band part 40 from being detached from the band insertion port 31.

The band part 40 (refer to FIG. 1) is a portion that extends in a band shape from the lock part 30 and can bind the wiring members W by being locked to the lock part 30 in a state of being wound around the wiring members W. The other end side of the band part 40 in the attachment direction Z is coupled to the lock part 30, and extends to the side opposite to the lock part 30 in the attachment direction Z. For example, the band part 40 is formed in such a manner that a cross-sectional shape orthogonal to the thickness direction is substantially rectangular and formed to have substantially the same thickness in the attachment direction Z, which is an extending direction. Note that, a part of the distal end side not illustrated of the band part 40 is formed so as to have a smaller cross-sectional shape and is formed in a tapered shape as it is closer to the distal end side.

The band part 40 has flexibility. The band part 40 is inserted into the band insertion port 31 of the lock part 30 by being wound along the outer peripheral surface (circumferential direction) of the wiring member W, and a surplus portion thereof can be drawn out from the band insertion port 31 in the width direction Y. On a surface of the band part 40, the locking groove not illustrated to be locked with the locking tooth 32 (refer to FIG. 2) formed in the band insertion port 31 is continuously provided. In the present embodiment, for example, in the direction in which the band part 40 is inserted into the band insertion port 31 in the width direction Y, locking (engagement) between the locking tooth 32 and the locking groove is released and insertion is allowed. In contrast, in a direction in which the band part 40 is pulled out in the width direction Y from the band insertion port 31, the locking (engagement) between the locking tooth 32 and the locking groove is not released, and a pulling operation (loosening operation) of the band part 40 cannot be performed.

As described above, a band clamp 1 and a wire harness WH of the present embodiment includes a clip part 10 that fits into an attachment hole 101 provided on an attachment panel 100 (attachment target) in an attachment direction Z, a flange part 20 provided on one end 10a side in the attachment direction Z of the clip part 10 and formed to have a diameter larger than a diameter of the clip part 10, a lock part 30 provided on one end 20a side of the flange part 20 in the attachment direction Z in which a band insertion port 31 penetrating in a width direction Y is formed, and a band part 40 that protrudes in a band shape from the lock part 30 and is locked to the band insertion port 31 in a state of being wound around a wiring member W extending in an axial direction X, in which the flange part 20 is provided with a guide surface 21 inclined toward the other end side in the attachment direction Z as it is separated from an open end 31a of the band insertion port 31 toward one end 20b side in the width direction Y of the flange part 20, the open end 31a is provided with a pair of tapered surfaces 33 inclined so as to spread toward both sides in the axial direction X as it is closer to one end 20b side of the flange part 20 in the width direction Y, and the lock part 30 protrudes such that one end 31a1 side in the attachment direction Z of the open end 31a is positioned closer to one end 20b side in the width direction Y of the flange part 20 than the other end 31a2 side.

With this configuration, the band clamp 1 and the wire harness WH can guide the distal end of the band part 40 toward the open end 31a side of the band insertion port 31 by the guide surface 21, the pair of tapered surfaces 33 and the like, for example. Since the one end 31a1 side of the open end 31a protrudes so as to be positioned closer to the one end 20b side in the width direction Y of the flange part 20 than the other end 31a2 side, it is possible to suppress the distal end of the band part 40 from being detached from the band insertion port 31. As a result, the band clamp 1 and the wire harness WH can improve an insertion property of the band part 40 into the band insertion port 31 of the lock part 30.

Note that, in the present embodiment, a case where the pair of arms 12 and the locking claws 13 are provided in the clip part 10 has been exemplified, but the number of arms 12 and locking claws 13 is not limited to this example, and for example, three or more arms 12 and locking claws 13 may be provided in the clip part 10. In this case, the plurality of arms 12 and locking claws 13 are arranged at regular intervals in a circumferential direction of the shaft 11.

Although the embodiment of the present invention has been exemplified above, the above embodiment is merely an example, and is not intended to limit the scope of the invention. The above-described embodiment can be implemented in various other forms, and various omissions, substitutions, combinations, and changes can be made without departing from the gist of the invention. Specifications (structure, type, direction, form, size, length, width, thickness, height, number, arrangement, position, material and the like) of each configuration, shape and the like can be appropriately changed and implemented.

A band clamp and a wire harness according to the present embodiment, a flange part is provided with a guide surface inclined toward the other end side in an attachment direction as it is separated from an open end of a band insertion port toward one end side in a width direction of the flange part, the open end is provided with a pair of tapered surfaces inclined so as to spread toward both sides in an axial direction as it is closer to the one end side in the width direction of the flange part, and the lock part protrudes such that one end side in the attachment direction of the open end is positioned closer to the one end side in the width direction of the flange part than the other end side. With this configuration, the band clamp and the wire harness can guide a distal end of the band toward the open end side of the band insertion port by the guide surface, the pair of tapered surfaces and the like, for example. As a result, the band clamp and the wire harness can improve the insertion property of the band part into the band insertion port of the lock part.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A band clamp comprising:
a clip part configured to fit into an attachment hole provided on an attachment target in an attachment direction;
a flange part provided on one end side of the clip part in the attachment direction and formed to have a diameter larger than a diameter of the clip part;
a lock part provided on one end side of the flange part in the attachment direction in which a band insertion port penetrating in a width direction intersecting the attachment direction is formed; and
a band part that protrudes in a band shape from the lock part and is locked to the band insertion port in a state of being wound around a wiring member extending in an axial direction intersecting the attachment direction and the width direction, wherein
the flange part is provided with a guide surface inclined toward the other end side in the attachment direction as the guide surface is separated from an open end of the band insertion port toward one end side of the flange part in the width direction,
the open end is provided with a pair of tapered surfaces inclined so as to spread toward both sides in the axial direction as the taper surfaces are closer to one end side of the flange part in the width direction, and
the lock part protrudes such that one end side of the open end in the attachment direction is positioned closer to one end side of the flange part in the width direction than the other end side of the open end.

2. A wire harness comprising:
a wiring member; and
a band clamp that supports the wiring member, wherein
the band clamp includes:
a clip part configured to fit into an attachment hole provided on an attachment target in an attachment direction;
a flange part provided on one end side of the clip part in the attachment direction and formed to have a diameter larger than a diameter of the clip part;
a lock part provided on one end side of the flange part in the attachment direction in which a band insertion port penetrating in a width direction intersecting the attachment direction is formed; and
a band part that protrudes in a band shape from the lock part and is locked to the band insertion port in a state of being wound around the wiring member extending in an axial direction intersecting the attachment direction and the width direction,
the flange part is provided with a guide surface inclined toward the other end side in the attachment direction as the guide surface is separated from an open end of the band insertion port toward one end side of the flange part in the width direction,
the open end is provided with a pair of tapered surfaces inclined so as to spread toward both sides in the axial direction as the tapered surfaces are closer to one end side of the flange part in the width direction, and
the lock part protrudes such that one end side of the open end in the attachment direction is positioned closer to one end side of the flange part in the width direction than the other end side of the open end.
